(19) United States
(12) Patent Application Publication
(10) Pub. No.: US 2026/0346489 A1
(43) Pub. Date: Nov. 5, 2026

(54) HANDLE FOR A PERSONAL CARE DEVICE

(71) Applicant: The Gillette Company LLC, Boston, MA (US)

(72) Inventors: Dominik JUELING, Hessen (DE); Christoph ZEGULA, Frankfurt (DE); Jan PRESSE, Hessen (DE)

(21) Appl. No.: 19/666,952

(22) Filed: May 4, 2026

Related U.S. Application Data
(60) Provisional application No. 63/799,946, filed on May 5, 2025.

(51) Int. Cl. B26B 21/52; B26B 21/40

(52) U.S. Cl. CPC B26B 21/526; B26B 21/528; B26B 21/4056

(57) ABSTRACT

A handle for a personal-care device with a housing defining a cavity. A light source is positioned within the cavity. A shaft is configured to move relative to the housing. The shaft has a portion within the cavity and a portion outside the cavity. A primary light guide is positioned within the cavity. A secondary light guide is mounted to the shaft. The secondary light guide has a portion within the cavity and a portion outside the cavity. A sealing gasket forms a watertight seal between an inner wall of the housing and the secondary light guide. The sealing gasket is positioned between the primary light guide and the secondary light guide. The sealing gasket facilitates movement of the secondary light guide relative to the primary light guide.

### FIELD

The present invention relates to an electronic personal care device and more particularly to a light guide assembly for small electronic appliances used in wet environments, such as a wet or dry shaving razors, toothbrushes or other grooming devices.

### BACKGROUND

Powered electronic devices are commonly provided with illuminated features that are aesthetically pleasing, indicate one or more functions of the device and provide feedback to a user. However, when such devices are used in a wet environment, providing such illuminated features can be problematic. Any electronic features that are not sealed from moisture may fail. In addition, components move or pivot further increases complexity when trying to provide light and/or a watertight seal. The wet environment necessitates providing a watertight seal that increases the complexity and cost of the illuminated features as well as limits the aesthetics and functionality of the device. The seal can also limit assembly and installation of the illuminated features within the housing.

What is needed, then, is an electronic personal care device, suitable for use in a wet environment, with one or more illumination systems, for example, a light guide positioned on a handle. The electronic personal care device, including powered razors and toothbrushes, is preferably simpler, cost-effective, reliable, durable, easier and/or faster to manufacture, and easier and/or faster to assemble with more precision.

### SUMMARY

In one aspect, the invention features, in general, a handle for a personal-care device with a housing defining a cavity. A light source is positioned within the cavity. A shaft is configured to move relative to the housing. The shaft has a portion within the cavity and a portion outside the cavity. A primary light guide is positioned within the cavity. A secondary light guide is mounted to the shaft. The secondary light guide has a portion within the cavity and a portion outside the cavity. A sealing gasket forms a watertight seal between an inner wall of the housing and the secondary light guide. The sealing gasket is positioned between the primary light guide and the secondary light guide. The sealing gasket facilitates movement of the secondary light guide relative to the primary light guide.

If desired, particular embodiments may optionally include the sealing gasket being a transparent material.

In another aspect, the invention features, in general, a method of assembling a handle for a personal-care device by mounting a light source within a cavity defined by a housing. A shaft is mounted within the cavity with a portion of a shaft within the cavity and a portion of the shaft outside the cavity. A primary light guide is positioned within the cavity between the light source and the shaft. A secondary light guide is mounted to the shaft with a portion of the secondary light guide within the cavity and a portion of the secondary light guide outside the cavity. A watertight seal is formed between an inner wall of the housing and the secondary light guide. A transparent sealing gasket is positioned between the primary light guide and the secondary light guide transferring light from inside the cavity to the portion of the secondary light guide outside of the cavity.

### BRIEF DESCRIPTION OF THE DRAWINGS

FIG. 1 is a top plan view of one possible embodiment of an electronic personal care device having an illumination assembly.

FIG. 2 is a top plan view of the electronic personal care device of FIG. 1 with a battery and a battery cap removed.

FIG. 3 is an enlarged assembly view of a portion of the electronic personal care device of FIG. 1.

FIG. 4 is a cross sectional view of a housing of the electronic personal care device, taken generally along the line 4-4 of FIG. 3.

FIG. 5 is a cross sectional view of the electronic personal care device, taken generally along the line 5-5 of FIG. 2.

FIG. 6 is a side view of a displacement transfer assembly.

### DETAILED DESCRIPTION

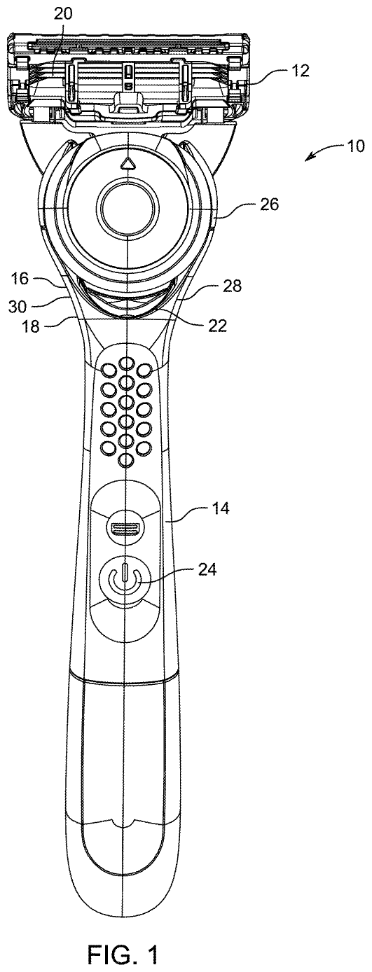

Referring to FIG. 1, one possible embodiment of the present invention is shown illustrating an electronic personal care device 10 that includes a cartridge 12 mounted to a handle 14 having an upper portion 16 with a light assembly 18. Although a wet shaving system is shown, the light assembly 18 may be utilized on any electronic personal care device that may used in wet environments, such as toothbrushes or dry shaving razors. The light assembly 18 may be utilized to provide a light source for various tasks, especially in dark or low-light conditions. However, it is also possible the light assembly is used to provide one or more signals to a consumer, such as an amount of pressure being exerted on a treatment surface by the electronic personal care device 10. The cartridge 12 may carry at least one blade 20 for shaving or trimming hair on the surface of skin. The cartridge 12 may be fixed or pivotably movable relative to the handle 14. In certain embodiments, the cartridge 12 may be mounted detachably to the handle 14 to enable the cartridge 12 to be replaced when sharpness of the blade 20 has diminished to an unsatisfactory level. Although the light assembly 18 is illustrated as being located on the top portion 16 of the handle 14, the light assembly 18 may be located on any surface of the handle 14, such as a bottom surface, a side surface, or at the back of the handle 14.

The light assembly 18 may include an external light guide 22, which may define a shape or symbol to communicate a function or status of the personal care device 10 (e.g., power is on or off). The light external guide 22 may form the shape of various icons, symbols, letters, numbers, or trademarks may also be used to illustrate a function of the handle 14. The external light guide 22 may also display an illuminated symbol that is as simple as a ring or a line, which may include only one symbol portion. The external light guide 22 may also be colored to further communicate a signal, such as the color red for a warning condition or the color green for a satisfactory condition. The external light guide 22 may be manufactured from a transparent or translucent material. In certain embodiments, the external light guide 22 may be injection molded from ABS (acrylonitrile butadiene styrene), PC, (polycarbonate), PMMA (polymethylmethacrylate), PP (polypropylene), SAN (styrene acrylonitrile), MBS (modified styrene acrylic copolymers), polymethyl pentene, and any combinations thereof. The external light guide 22 may be solid such that light travels through the material of the external light guide 22 in order to exit the external light guide 22 and not through a hollow or open space in the external light guide 22. The external light guide 22 may be exposed to a user's environment and thus may be subject to moisture. The handle 14 may include an actuator 24, such as a button or a switch, for turning on and off-directly or indirectly-the external light assembly 22.

The electronic personal care device 10 may include a head 26 located between the handle 14 and the cartridge 12. In certain embodiments, the head 26 may move (e.g., pivot) relative to the handle 14. For example, the external light guide 22 may be positioned on the handle 14 and the head 26 may move (e.g., pivot) relative to the external light guide 22. The external light guide 22 may direct light in one or more directions, such as forward (i.e., towards the cartridge 12), upward and/or to the sides 28 and 30 of the handle 14.

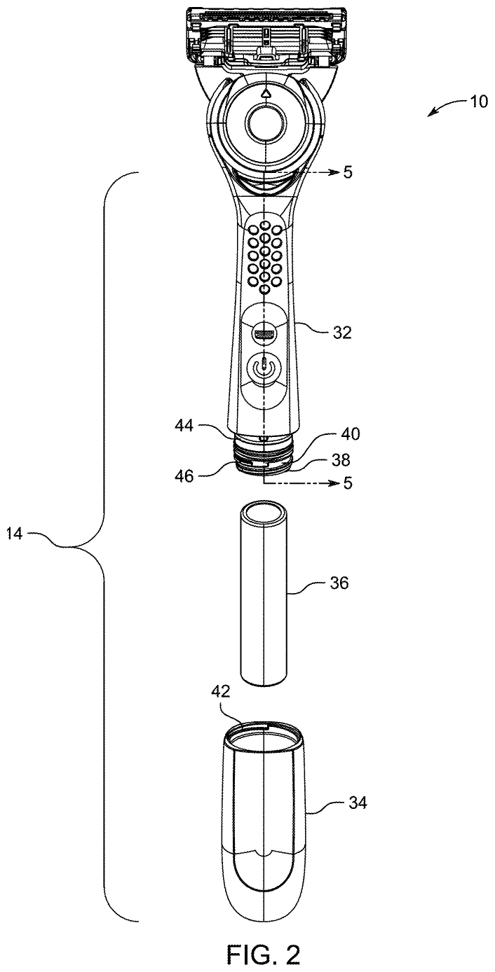

Referring to FIG. 2, an assembly view of the electronic personal care device 10 of FIG. 1 is illustrated. The handle 14 may include a housing 32 and a cap 34. A battery 36 may be inserted into a cavity (not shown) defined by the housing 32. The cap 34 may be mounted to an end 38 of the housing 32 to secure the battery 36 in place and form an electrical connection for the electronic personal care device 10. The end 38 of the housing 32 may have one or more locking members 40 (e.g., threads) that engage one or more corresponding locking members 42 on the cap 34. One or more gaskets 44 and 46 may be mounted to the end 38 of the housing 32 to provide a watertight seal and/or facilitate outgassing of the battery 36 including general pressure balancing between inside and outside.

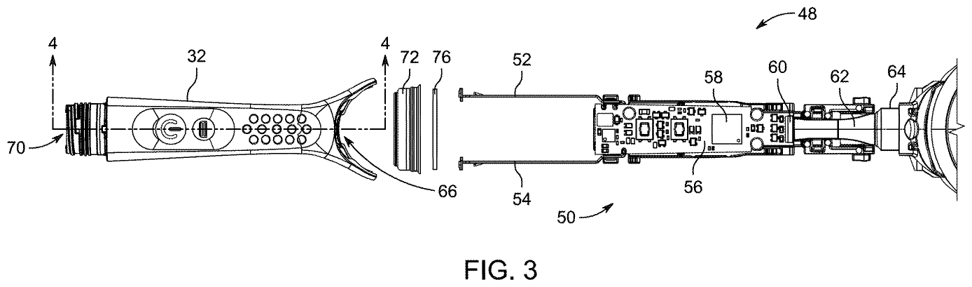

Referring to FIG. 3, an assembly view of a housing assembly 48 is illustrated. The housing assembly 48 may include the housing 32 and an electronic subassembly 50. The electronic subassembly 48 may include one or more conductor rails 52 and 54 to supply power from the battery 36 (FIG. 2) to a printed circuit board (PCB) 56 of the electronic subassembly 48. A central processing unit such as microcontroller or any other integrated circuit 58 may be mounted to the printed circuit board (PCB) 56 to carry out various processing functions, such as controlling LEDs, sensors and/or motors. For example, microcontroller 58 may control one or more LEDs (hidden by a cover 60) mounted to the printed circuit board 56. Alternatively, the LED may include a sideview LED such that light is directed in the forward direction essentially parallel to the PCB. As will be described in greater detail below, the cover 60 may help direct light to a first light guide 62 that further directs light to a second light guide 64.

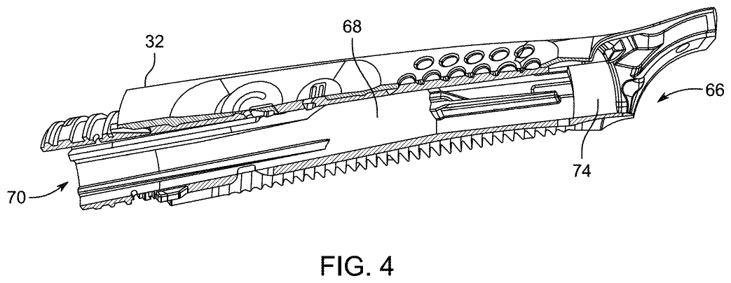

The electronic subassembly 50 may be inserted into a first opening 66 or a second opening 70 defined by the housing 32. It is understood that various sub-components of the electronic subassembly 50 may be assembled in the housing 32 together or separately. The electronic subassembly 50 may be positioned and secured within a cavity 68 (FIG. 4) defined by the housing 32. In certain embodiments, the one or more conductor rails 52 and 54 may extend to the second opening 70 defined by the housing 32 (opposite the first opening 66). In certain embodiments, prior to insertion of the electronic subassembly 50 into the housing 32, a sealing gasket 72 may be positioned around the second light guide 64. Accordingly, the sealing gasket 72 may be positioned between the second light guide 64 and the housing 32 (e.g., an inner wall 74 of the housing 32, as shown in FIG. 4). The sealing gasket 72 may be comprise LSR, TPE, or other transparent or translucent soft polymers. In certain embodiments, a pressure ring 76 may be positioned within the sealing gasket 72 to facilitate expansion of the sealing gasket 72 against the inner wall 74 of the housing 32 (FIG. 4), thus forming a watertight seal to limit the ingress of water into the cavity 68, which may damage the electronic subassembly 50. In certain embodiments, the sealing gasket 72 may be transparent or translucent to facilitate the transmittance of light from within the cavity 60 to outside of the cavity 60.

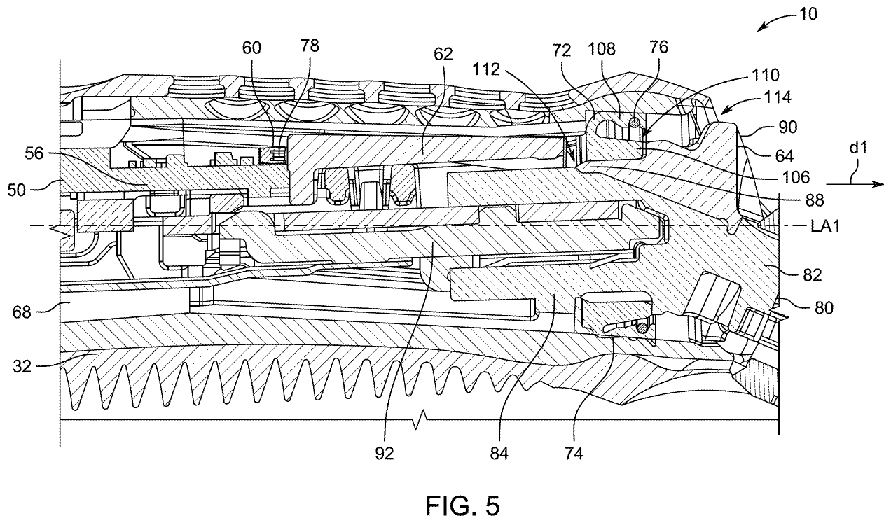

Referring to FIG. 5, a cross sectional view of the electronic personal care device 10 of FIG. 2 is illustrated, taken generally along the line 5-5 of FIG. 2. A light source 78, such as an LED, may be positioned within the cavity 68 of the housing 32. For example, the light source 78 may be mounted to the printed circuit board (PCB) 56. The cover 60 may be positioned over the light source 78 to direct light from the light source 78 to the first light guide 62, positioned within the cavity 68. For example, light from the light source 78 may be blocked on 4 sides (e.g., top, two lateral sides, and rear) thus allowing light to transmit in a forward direction, toward the first light guide 62. Alternatively, a so-called sideview LED can be used which only emits light in a direction parallel to the PCB 56. The first light guide 62 may transmit light to the second light guide 64 (i.e., the first light guide 62 may be positioned between the second light guide 64 and the light source 78). The first light guide 62 and the second light guide 64 may comprise a transparent or translucent polymeric material, such as ABS (acrylonitrile butadiene styrene), PC, (polycarbonate), PMMA (polymethylmethacrylate), PP (polypropylene), SAN (styrene acrylonitrile), MBS (modified styrene acrylic copolymers), polymethyl pentene, and any combinations thereof.

The secondary light guide 64 may include a shaft 80. The shaft 80 may have a portion 82 positioned outside of the cavity 68 and a portion 84 positioned within the cavity 68. In certain embodiments, the shaft 80 and the second light guide 64 may be integral. For example, the shaft 80 and the second light guide 64 may be co-injection molded together to form a unitary component. However, it is understood that other manufacturing methods may be used to mount the shaft 80 to the secondary light guide 64. In certain embodiments, the shaft 80 may be opaque to block light from the first light guide 62, thus allowing light only to be transmitted outside of the cavity 68 through the secondary light guide 64. However, it is understood that the shaft 80 and the secondary light guide 64 may comprise the same material to allow full transmittance of light from inside the cavity 68 to outside the cavity 68. The sealing gasket 72 may be positioned between the secondary light guide 64, which may also include the shaft 80, and the inner wall 74 of the housing 32 to form a watertight seal.

Light may be transmitted in a direction along a longitudinal axis (LA1) of the housing 32. For example, light may be transmitted from the light source 78 in a forward direction (i.e., direction d1). The secondary light guide 64 may have a portion 88 inside of the cavity 68 and a portion 90 outside of the cavity 68 (i.e., visible to a user). Accordingly, light may be transmitted from the light source 78, to the primary light guide 62, to the portion 88 of the secondary light guide 64 inside of the cavity 68, and then to the portion 90 of the secondary light guide 64 outside of the cavity 68 where it can be viewed by the user. Light may be transmitted from the light source 78, to the primary light guide 62 through the sealing gasket 72 then to the secondary light guide 64. It is understood that in other embodiments, the light may also be transmitted through the shaft 80. For example, light may be transmitted from the light source 78, to the primary light guide 62, to the portion 84 of the shaft 80 positioned within the cavity 68, and then to the portion 82 of the shaft 80 positioned outside of the cavity 68. Accordingly, the shaft 80 (e.g., portion 82) and/or the secondary light guide 64 (e.g., the portion 90) may be the only portions having transmitted light outside of the cavity 68. For example, the sealing gasket 72 may be positioned within the cavity 68 of the housing 32. The shaft 80 (e.g., portion 82) and/or the secondary light guide 64 (e.g., the portion 90) may provide for a better quality of light compared to the sealing gasket 72, which may be more limited because of its more important sealing functionality.

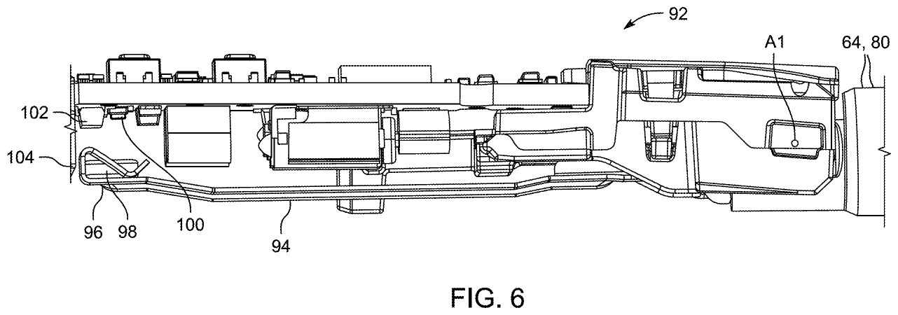

In certain embodiments, the sealing gasket 72 may prevent water ingress into the cavity 68. The sealing gasket 72 may also facilitate the shaft 80 and/or the secondary light guide 64 to move (e.g., pivot) relative to the housing 32. For example, as a user presses the cartridge 12 (FIG. 1), against a treatment surface, such as the face or body, force may be transferred from the cartridge 12 (FIG. 1) to the head 26 (FIG. 1) and to the shaft 80 and/or the secondary light guide 64. The shaft 80 and/or the secondary light guide 64 may be coupled to a displacement transfer assembly 92 having a pivot axis A1 positioned within the cavity 68 of the housing 32 (see FIG. 6).

Referring to FIG. 6, a side view of the displacement transfer assembly 92 is illustrated. The displacement transfer assembly 92 may include a displacement transfer arm 94 mounted to the secondary light guide 64 and/or the shaft 80. An end 96 of the displacement transfer arm 94 may include a location element 98. A displacement sensor 100 may be positioned on the printed circuit board 56, adjacent the location element 98. The location element 98 may comprise a magnet, a visual marker, or an electrically conductive material. Alternatively, the location element 98 may comprise a light reflecting surface or an electric field manipulation element. The displacement sensor 100 may comprise a magnetometer, an electric field sensor or a light source and sensor. An example of a magnetometer may include a Hall Effect sensor. A stop 102 may be mounted to the printed circuit board 56 to prevent the location element 98 from contacting the displacement sensor. For example, a protrusion 104 at the end 96 of the displacement transfer arm 94 may contact the stop 102, thus preventing the location element 98 from contacting the displacement sensor 100. Accordingly, the stop 102 helps prevent the location element 98 from damaging the displacement sensor 100.

As the displacement transfer arm 94 pivots about the pivot axis A1 (i.e., relative to the housing 32), the location element 98 may move relative to displacement sensor 100. For example, as the displacement transfer arm 94 pivots, the location element 98 also moves. The displacement sensor 100 may detect small changes in magnetic field due to the movement of location element 98 (e.g., magnet). The displacement sensor 100 may then transfer a related signal to the microcontroller 58 (FIG. 3). Accordingly, movement of the shaft 80 and/or the secondary light guide 64 may interact with one or more sensors (e.g., the displacement sensor 100) connected to the microcontroller 58 that activates one or more components, such as the light source 78 (FIG. 5). For example, if a user applies too much pressure to a treatment surface, the microcontroller 50 may send a first signal to the light source (e.g., to produce a red colored light). The light source 78 may be an RGB LED that is capable of producing multiple different colors of light. However, it is understood that the light source 78 may also include multiple LEDs. In certain embodiments, the primary light guide 62 may be spaced apart from the secondary light guide 64 and/or the shaft 80 to facilitate movement (e.g., pivoting) of the secondary light guide 64 and/or the shaft 80 relative to the housing 32 (FIG. 5).

Referring to FIG. 5, in an unbiased position the shaft 80 and/or the secondary light guide 64 may be completely spaced apart from the housing 32 to allow free movement. The sealing gasket 72 may facilitate movement of the secondary light guide 64 and/or the shaft 80. In certain embodiments, the sealing gasket 72 may have an inner portion 106 sealed against the secondary light guide 64 and an outer expansible portion 108 sealed against the housing 32. The pressure ring 76 may be positioned between the expansible portion 108 and the secondary light guide 64. The pressure ring 76 may bias the expansible portion 108 of the sealing gasket 72 against the housing 32 to provide sufficient pressure between the sealing gasket 72 (e.g., the outer expansible portion 108) and the housing 32. The inner portion 106 and the outer expansible portion 108 define a gap 110. The gap 110 may facilitate the movement of the secondary light guide 64 and/or the shaft 80. For example, the gap 110 may open and close as the secondary light guide 64 and/or the shaft 80 move (e.g., pivot relative to the housing 32). The shaft 80 and/or the secondary light guide 64 may completely spaced apart from the housing 32 in an unbiased position, as the sealing gasket 72 may prevent contact with the housing 32.

In certain embodiments, the shaft 80 and/or the secondary light guide 64 may be spaced apart from the primary light guide 62 to provide a gap 112 to allow for free movement of the shaft 80 and/or the secondary light guide 64. The sealing gasket 72 may also be positioned between the primary light guide 62, the shaft 80 and/or the secondary light guide 64 to prevent contact with the primary light guide 62. In certain embodiments, the primary light guide 62 may be mounted to the printed circuit board 56 and if the shaft 80 and/or the secondary light guide 64 move against the primary light guide 62 and/or the printed circuit board 56, damage may result which could lead to malfunction of the electronic subassembly 50. The portion 90 of the secondary light guide 64 outside of the cavity 68 and the housing 32 may define a gap 114 to provide clearance for the secondary light guide 64 to move (e.g., pivot) relative to the housing 32. As the secondary light guide 64 moves, the transmission of light may not be negatively affected as light is able to be continuously transmitted to the secondary light guide (e.g., the portion 90 of the secondary light guide 64 outside of the cavity 68) without interference.

### REPRESENTATIVE EXAMPLES

A. A handle for a personal-care device comprising a housing defining a cavity; a light source positioned within the cavity; a shaft having a portion within the cavity and a portion outside the cavity, the shaft configured to move relative to the housing; a primary light guide positioned within the cavity; a secondary light guide mounted to the shaft, the secondary light guide having a portion within the cavity and a portion outside the cavity; a sealing gasket forming a watertight seal between an inner wall of the housing and the secondary light guide; wherein the sealing gasket is positioned between the primary light guide and the secondary light guide and the sealing gasket facilitates movement of the secondary light guide relative to the primary light guide.
B. The handle of paragraph A wherein the secondary light guide is injection molded to the shaft.
C. The handle of any one of paragraphs A-B wherein the secondary light guide pivots relative to the housing.
D. The handle of any one of paragraphs A-C wherein the shaft has a pivot axis (A1) within the cavity.
E. The handle of any one of paragraphs A-C wherein the primary light is spaced apart from the secondary light guide.
F. The handle of any one of paragraphs A-E wherein the sealing gasket comprises an inner portion sealed against the secondary light guide and an outer expansible portion sealed against the housing.
G. The handle of claim F further comprising a pressure ring between the expansible portion and the secondary light guide.
H. The handle of any one of paragraphs F-G wherein the inner portion and the outer expansible portion define a gap.
I. The handle of any one of paragraphs A-H wherein the shaft is completely spaced apart from the housing in an unbiased position.
J. The handle of any one of paragraphs A-I further comprising a displacement transfer arm extending from the shaft.
K. The handle of any one of paragraphs A-J wherein the secondary light guide is integral with the shaft.
L. The handle of any one of paragraphs A-K wherein the primary light guide is spaced apart from the shaft.
M. The handle of any one of paragraphs A-L further comprising a cartridge having at least one blade wherein the cartridge is mounted to the handle.
N. The handle of any one of paragraphs A-M wherein the shaft comprises an opaque material.
O. The handle of any one of paragraphs A-N wherein sealing gasket comprises a transparent material.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”. In an effort to avoid any ambiguity, for the purposes of this disclosure, the term “portion” shall be construed as meaning less than 50%. For example, the term “distal end portion” should be interpreted as from about 0%, 5%, 10%, or 15% to about 15%, 20%, 25%, 30%, 40% or 45% from the terminal end of the element referenced. Similarly, the term “proximal end portion” should be interpreted as from about 0%, 5%, 10%, or 15% to about 15%, 20%, 25%, 30%, 40% or 45% from the end opposite the terminal end of the element referenced.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to anything disclosed or claimed herein or that it alone, or in any combination with any other reference or references, teaches, suggests or discloses anything disclosed or claimed herein. Further, to the extent that any meaning or definition of a term in this document conflicts with any meaning or definition of the same term in a document incorporated by reference, the meaning or definition assigned to that term in this document shall govern.

While particular forms of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A handle for a personal-care device comprising:
a housing defining a cavity;
a light source positioned within the cavity;
a shaft having a portion within the cavity and a portion outside the cavity, the shaft configured to move relative to the housing;
a primary light guide positioned within the cavity;
a secondary light guide mounted to the shaft, the secondary light guide having a portion within the cavity and a portion outside the cavity;
a sealing gasket forming a watertight seal between an inner wall of the housing and the secondary light guide; wherein the sealing gasket is positioned between the primary light guide and the secondary light guide and the sealing gasket facilitates movement of the secondary light guide relative to the primary light guide.

2. The handle of claim 1 wherein the secondary light guide is injection molded to the shaft.

3. The handle of claim 1 wherein the secondary light guide pivots relative to the housing.

4. The handle of claim 1 wherein the shaft has a pivot axis within the cavity.

5. The handle of claim 1 wherein the primary light guide is spaced apart from the secondary light guide.

6. The handle of claim 1 wherein the sealing gasket comprises an inner portion sealed against the secondary light guide and an outer expansible portion sealed against the housing.

7. The handle of claim 6 further comprising a pressure ring between the expansible portion and the secondary light guide.

8. The handle of claim 6 wherein the inner portion and the outer expansible portion define a gap.

9. The handle of claim 1 wherein the shaft is completely spaced apart from the housing in an unbiased position.

10. The handle of claim 1 further comprising a displacement transfer arm extending from the shaft.

11. The handle of claim 1 wherein the secondary light guide is integral with the shaft.

12. The handle of claim 1 wherein the primary light guide is spaced apart from the shaft.

13. The handle of claim 1 further comprising a cartridge having at least one blade wherein the cartridge is mounted to the handle.

14. The handle of claim 1 wherein the shaft comprises an opaque material.

15. The handle of claim 1 wherein sealing gasket comprises a transparent material.

16-20. (canceled)
